(19) United States
(12) Patent Application Publication
(10) Pub. No.: US 2018/0343732 A1
(43) Pub. Date: Nov. 29, 2018

(54) THREE-PHASE AC TO DC ELECTRICAL TRANSFORMER

(71) Applicant: Tibbar Plasma Technologies, Inc., Los Alamos, NM (US)

(72) Inventors: Keith Moser, Libertyville, IL (US); Richard Nebel, Los Alamos, NM (US); John Finn, Los Alamos, NM (US); Cihan Ackay, Los Alamos, NM (US); Liviu Popa-Simil, Los Alamos, NM (US); William Gibson, Los Alamos, NM (US); Daniel Barnes, Lamy, NM (US); Aaron McEvoy, Los Alamos, NM (US); Juan Fernandez, Los Alamos, NM (US)

(21) Appl. No.: 15/602,298

(22) Filed: May 23, 2017

(51) Int. Cl. H05H 1/16; H02M 7/02; H01F 27/29

(52) U.S. Cl. CPC H05H 1/16; H01F 27/29; H02M 7/02

(57) ABSTRACT

An alternating current to direct current electrical transformer system, based on helical electrodes applied to a plasma in a chamber. A three-phase AC input voltage is be applied to helically shaped electrodes in the chamber, and a DC output is taken from endcap electrodes at opposite the ends of the device. The secondary current is taken from solid or optionally split or slotted electrodes at the ends of the device. The system uses plasma, input electrodes, an axial magnetic field and a conducting wall that acts as a flux conserver for the frequency of the AC power. The system includes apparatus which contains a radial magnetic field embedded in the helical electrodes. The system also offers methods for changing the output voltage and current relative to the input values. Thus, the system can function as either a stepup or a stepdown transformer.

### CROSS-REFERENCE TO RELATED APPLICATIONS

This application is related to U.S. patent application Ser. Nos. 14/648,014, 15/209,907, 15/336,508, 15/338,197, and 15/339,774, filed 28 May 2015, 14 Jul. 2016, 27 Oct. 2016, 28 Oct. 2016, and 31 Oct. 2016, respectively, the entire disclosures of which are hereby incorporated by reference.

### STATEMENT REGARDING FEDERALLY SPONSORED RESEARCH OR DEVELOPMENT

This invention was made with Government support under Award No. DE-AR0000677, awarded by the Advanced Research Projects Agency-Energy (ARPA-E), U.S. Department of Energy. The Government has certain rights in this invention.

### BACKGROUND OF THE INVENTION

An electrical transformer based on helical electrodes applied to a plasma is described hereinafter. As indicated in U.S. patent application Ser. No. 15/209,907, a three-phase AC input voltage may be applied to the helical electrodes and a DC output is taken from endcap electrodes at opposite the ends of the device. The presently disclosed device also contains a radial magnetic field embedded in the helical electrodes and the secondary current is taken from solid or possibly split (slotted) electrodes at the ends of the device. The systems of the present disclosure also provide methods for changing the output voltage and current relative to the input values. Thus, the present apparatus can work as either a stepup or a stepdown transformer. Although conventional methods can provide high voltage DC (HVDC) for long distance transmission, such methods are complex and costly. These and other shortcomings are addressed by the present disclosure.

### SUMMARY OF THE INVENTIVE DISCLOSURE

It is to be understood that both the following summary and the following detailed description are exemplary and explanatory only and are not restrictive. Provided are methods and systems for, in one aspect, providing and managing DC power. Provided also are methods and systems for, in another aspect, transforming three-phase AC to DC power.

In an aspect of the systems and methods of the present disclosure, there is provided means and process to transform three-phase AC voltages and currents to DC voltages and currents, while minimizing cost and complexity. In another aspect, instead of using wires and iron cores similar to known AC to AC transformers, the three-phase AC to DC transformer systems of the present disclosure can comprise plasma, helical electrodes, an axial magnetic field and a conducting wall that acts as a flux conserver for that frequency of the AC power. As an example, the transformation of the three-phase AC to DC voltages and currents can be based on magnetohydrodynamics (MHD) behavior.

In another aspect, an example system can comprise plasma disposed in a housing and three or more helical electrodes disposed in the housing, wherein an electric current passing through three or more helical electrodes induces helical flow in the plasma. Conductive endcaps can be coupled to the housing and the helical electrodes.

In another aspect, an example system can comprise plasma disposed in a housing, wherein an electric current passing through the three or more helical electrodes directly drive current parallel to the magnetic field in the plasma. Conductive endcaps can be coupled to the housing and the helical electrodes.

In another aspect, a method can comprise generating a magnetic field through plasma and generating a helical flow in the plasma, thereby generating an electric current.

In another aspect, an example apparatus can comprise a chamber configured to contain plasma. The apparatus can comprise at least three input electrodes disposed at least partially within the chamber and configured to convey a three-phase alternating current into the chamber, with each phase differing in time by 120 degrees, placed 120 degrees apart in spatial angle. The at least three input electrodes can be configured to direct the three-phase alternating current to induce motion in the plasma. The apparatus can comprise at least two endcap electrodes extending from the chamber, preferably for outputting current. The at least two endcap electrodes can be configured to conduct a DC current from the chamber based on the induced motion in the plasma. If two or more output endcap electrodes are used, DC current can be conducted from the chamber.

In another aspect, an example method can comprise conveying a first three-phase alternating current into a chamber, inducing motion in a plasma contained in the chamber based on the alternating current, driving parallel current directly in the plasma because of the radial magnetic field in the electrodes, and receiving a direct current from the chamber based on the induced motion of the plasma.

In another aspect, an example system can comprise a transformer with high efficiency by including applying a radial magnetic field. The purpose of this radial magnetic field is to drive directly a current in the plasma parallel to the magnetic field, in addition to the current driven due to the plasma helical flow induced by the applied electrostatic field from the helical electrodes.

In another aspect, the pitch of the helical electrodes may be varied to optimize the efficiency of the transformer, as well as to change the ratio of output voltage to input voltage.

In another aspect, the length of the device may be varied to optimize the transformer efficiency, and to determine the ratio of the output voltage to the input voltage.

In another aspect, the radial magnetic field through the primary helical electrode may develop spontaneously by diffusing through the electrode. A wall, which is a good conductor on the 60 Hz time scale (of sufficient conductivity and thickness), is present. The radius of this wall may be used to fix the radial magnetic field to the appropriate magnitude for this optimization. In another aspect, a feedback system will be used to control the value of the radial magnetic field in the helical electrodes.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as the scope of the invention is set forth in the claims and equivalents thereto.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a plot of the transformer efficiency, scaled to its peak value, as a function of the radial magnetic field Br, scaled to the solenoidal field.

FIG. 2 is a diagrammatic sectional view of the three-phase AC to DC transformer;

FIG. 3 is a block diagram of an exemplary computing device in accordance with the present invention;

FIG. 4 is a perspective view of an exemplary transformer system according to the present invention;

FIG. 5A is a perspective view of the transformer without the solenoidal coils and thick conducting wall, according to the present invention;

FIG. 5B is expanded axially with the housing cutaway to show the helical electrodes;

FIG. 6 is a cross-section view of an exemplary transformer system;

FIG. 7 is a flow diagram of an exemplary method of controlling the plasma by the solenoidal coils, providing the axial magnetic field and its correction to the external circuits;

FIG. 8 is a schematic of the three-phase AC to DC transformer;

FIG. 9 is a flow chart illustrating the transformer for converting a voltage and/or an electrical current;

The various views are not necessarily to scale, either within a particular view or between views.

### DETAILED DESCRIPTION OF EMBODIMENTS

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Herein disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this disclosure including, but not limited to, steps in disclosed methods. Thus, if there are a variety of additional steps that can be performed, it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following descriptions.

As will be appreciated by one skilled in the art, the methods and systems disclosed herein, and sub-methods and subsystems, may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software routines and algorithms. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It is understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

The computer program instructions according to this disclosure may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus, to produce a computer-implemented process such that the instructions that are executed on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and methods, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The systems and methods of the present disclosure generally involve inducing a helical flow in plasma, and exploiting the plasma flow to realize a current transformation or conversion. Flows can be induced in plasmas by applying an electric field perpendicular to the magnetic field. The ideal MHD Ohm's law can be written as:

E+VxB=0, (1)

where E is the local electric field, V is the local plasma velocity, and B is the local magnetic field, and x signifies the vector cross product. Bold face indicates quantities which are vectors.

If equation (1) is crossed with the magnetic field B, it can be determined that the plasma flow perpendicular to the magnetic field (denoted as V_{ExB} and commonly referred to as the ExB drift velocity) becomes, in the ideal MHD limit:

V_{ExB}=(ExB)/B², (2)

where x signifies the vector cross product and B² is the vector dot product of B with itself.

In order for the ExB drift velocity to change the magnetic field significantly it must be comparable to the Alfven speed (V_{A}) which can be expressed as:

V_{A}=B/(μ₀ρ)^{1/2}, (3)

where B=|B| is the magnitude of the magnetic field, ρ is the mass per unit volume, and μ₀ is the permittivity of free space. Equation (1) can be combined with Faraday's law:

∂B/∂t=−curl(E) (4)

and integrated over a surface. As such, the result calculation provides that the magnetic field lines (or the magnetic flux) are substantially frozen into the plasma in ideal MHD. As an example, the magnetic field lines convect with the plasma.

When plasma velocities approach the Alfven speed (V_{A}) the plasma velocities can bend the magnetic field lines. Thus, if a velocity shear is induced in the perpendicular velocity (e.g., the V_{ExB} drift velocity), the magnetic field can be significantly modified, provided that the flow speeds are near the magnitude of the Alfven speed V_{A}.

Three-dimensional nonlinear plasma simulations in resistive MHD can be used to confirm aspects of the phenomenon described herein above. As an example, a simulation code similar to that implemented in A. Y. Aydemir, D. C. Barnes, E. J. Caramana, A. A. Mirin, R. A. Nebel, D. D. Schnack, A. G. Sgro, Phys Fluids 28, 898 (1985) and D. D. Schnack, D. C. Barnes, Z. Mikic, D. S. Harned, E. J. Caramana, R. A. Nebel, Computer Phys Comm 43, 17 (1986), can be used. As a further example, plasma can be simulated in cylindrical geometry.

In an aspect, an axial magnetic field can be applied along a helical electric field (e.g., provided via three helical electrodes on the boundary.) The helical plasma state can produce a magnetic field with a radial component through the helical electrodes. This component may be controlled by a wall of high electrical conductivity and thickness to act as a flux conserver for this frequency of AC operation, or may be controlled by a feedback system.

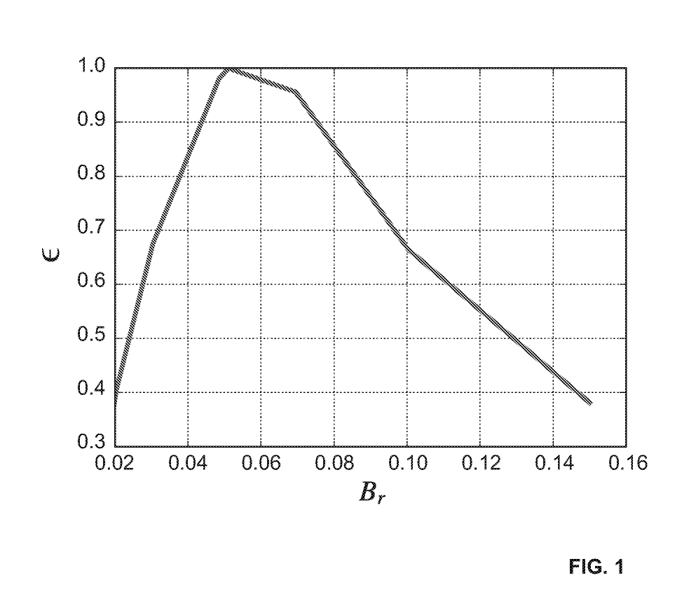

Three-dimensional resistive MHD simulations can be used to simulate the transformer performance for a primary circuit delivering three-phase AC voltage and current: for three helical electrodes supplying three-phase AC voltage and current, separating the three electrodes by 120 degrees provides an applied electric field that rotates rigidly in space at 60 Hz, so that in the rotating frame the applied electric field is DC. Three-dimensional resistive MHD simulations in this rotating frame show that the magnetic field lies on surfaces with helical distortion supplied by the helical electrode current and by the rotating radial magnetic field penetrating the helical electrodes. For a sufficiently large value of the radial magnetic field, simulations show that the current density J_{z} is of a single sign, allowing solid electrodes as in patent application Ser. No. 14/648,014. The radial magnetic field in the helical electrodes will grow if the resistive time of the helical electrodes is shorter than the 60 Hz time scale. The optimum value for the radial magnetic field in this disclosure will be provided by an external thick conducting wall, allowing no magnetic flux penetration on the 60 Hz time scale, or by a feedback system. The radial magnetic field will be controlled to have the optimal value by the position of this conducting wall. Three-dimensional resistive MHD simulations show that the efficiency peaks at a specific value of the radial magnetic field. For example, the efficiency as a function of the radial magnetic field Bᵣ is shown in FIG. 1, showing a peak at an intermediate value. These simulations also show that to obtain favorable values for the efficiency, this peak in efficiency must be optimized with respect to the back EMF of the secondary circuit, the voltage on the primary circuit, the pitch of the helical electrodes, the length of the device, and the plasma temperature.

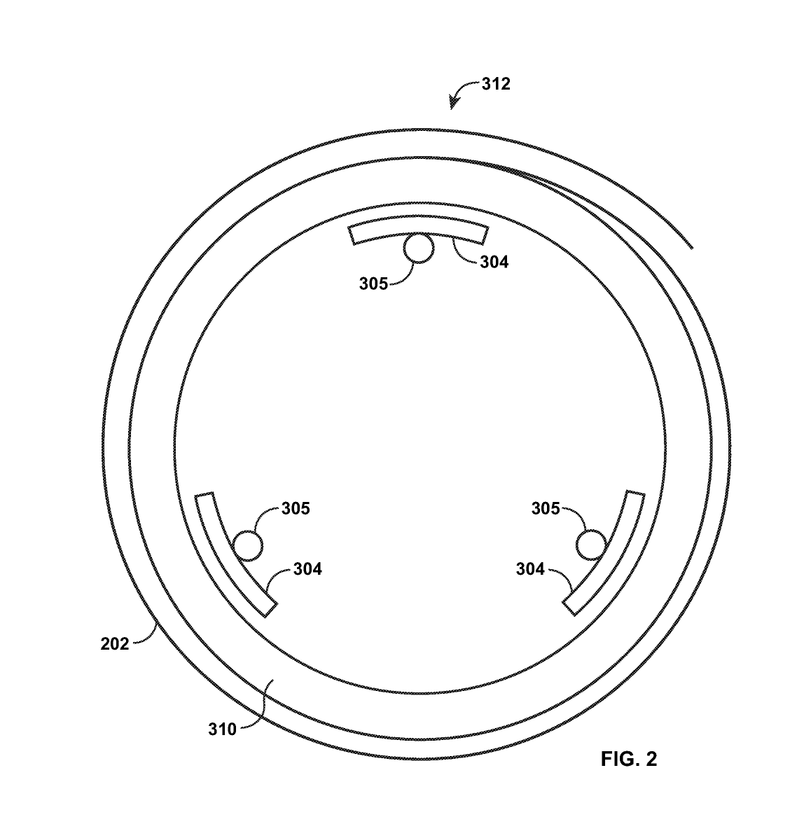

FIG. 2 is a radial sectional view of the three-phase AC to DC transformer 312, with three helical electrodes 304, helical electrode leads 305, a vacuum chamber vessel defined within a thick flux-conserving wall 310, and magnetic coils 202 for generating the axial field.

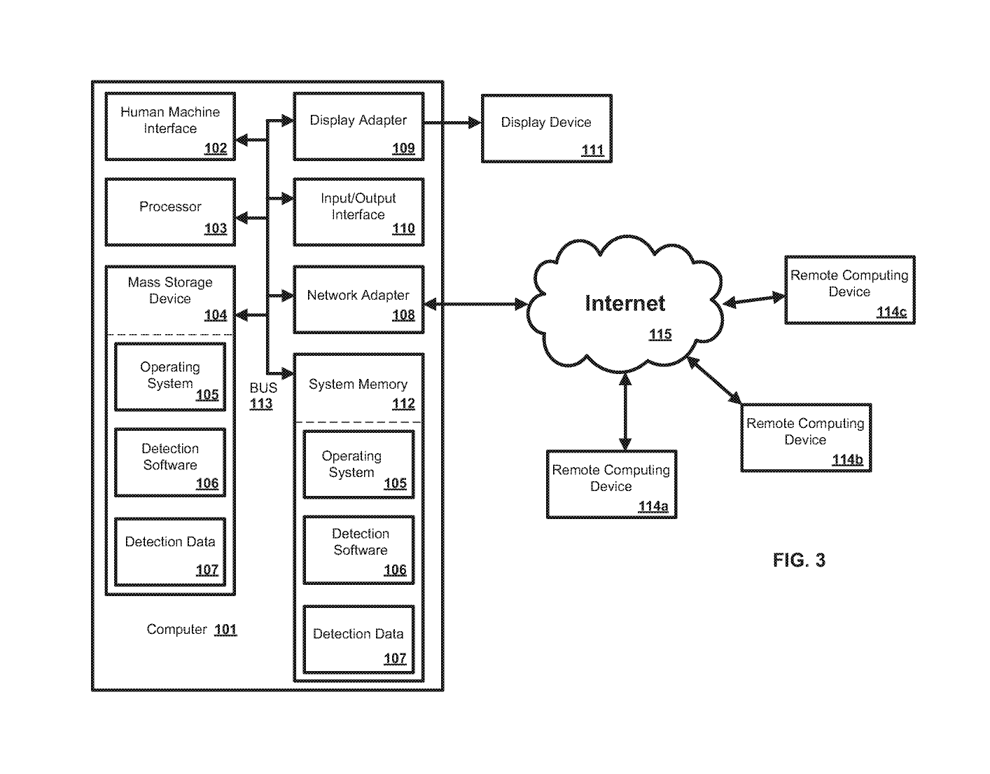

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, dynamos, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc., that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

With attention invited to FIG. 3, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, detection software 106, detection data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as detection data 107 and/or program modules such as operating system 105 and detection software 106 that are immediately accessible to and/or are presently operated on by the processing unit 103.

The computer 101 may also comprise other removable/non-removable, volatile/non-volatile computer storage media. By way of example, FIG. 3 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and detection software 106. Each of the operating system 105 and detection software 106 (or some combination thereof) can comprise elements of the programming and the detection software 106. Detection data 107 can also be stored on the mass storage device 104. Detection data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

A user can enter commands and information into the computer 101 via an input device (not shown). Examples of known such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

A display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a, b, c. By way of example, a remote computing device can be a personal computer, portable computer, a server, a router, a network computer, a peer device or other common network node, and so on. Logical connections between the computer 101 and a remote computing device 114a, b, c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein, particularly with reference to FIG. 3, as discrete blocks, although it is recognized that such programs and components reside at various times in different storage components of the computing device 101, and are executed by the data processor(s) of the computer. An implementation of simulation software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

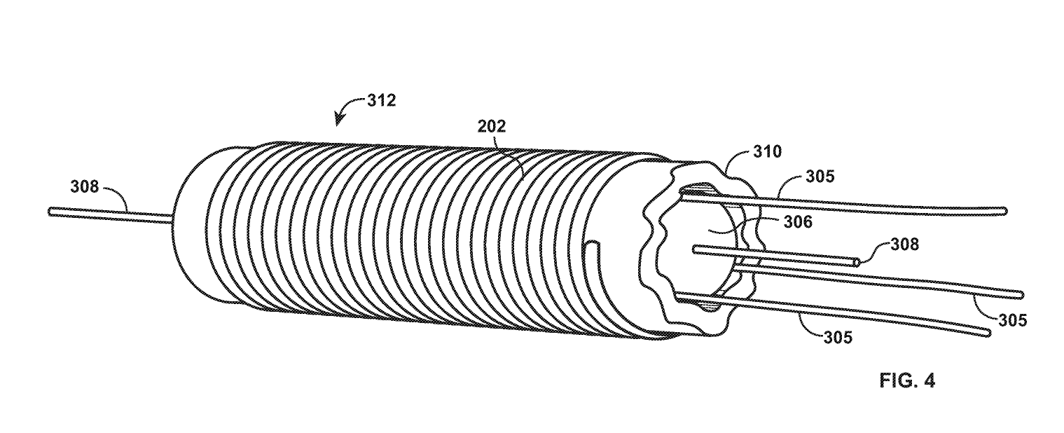

FIG. 4 illustrates the three-phase AC to DC transformer system 312 according to the present disclosure. Electric current passes through the solenoid 202 disposed around the plasma chamber and induces a magnetic field in the axial direction within the chamber. Three-phase AC power is supplied to the at least three helical electrodes (within the chamber, not seen in FIG. 4) via the connected leads 305 (nominally the input leads). A radial magnetic field is generated or provided by the helical motion of the plasma in the chamber due to the helical electrostatic drive, and is controlled by a chamber conducting wall 310 of sufficient conductivity and thickness, and appropriate distance from the primary (helical) electrodes. There also are provided at least two endcap electrodes 306 (one at each end of the chamber, only one shown in FIG. 4). The at least two endcap electrodes 306 are configured to conduct a direct current from the chamber through associated endcap leads 308. Thus, the secondary current is taken from solid or possibly split (slotted) electrodes at the ends of the chamber. Configurations and makeup of split or slotted endcap electrodes are disclosed generally in co-pending U.S. patent application Ser. No. 15/336,508 (“DC-DC Electrical Transformer”) and in co-pending U.S. patent application Ser. No. 15/339,774 (“Three Phase Alternating Current to Three Phase Alternating Current Electrical Transformer”), both of which are here incorporated by reference. The voltage and current as output from the chamber is based on the induced motion in the plasma and the parallel current density driven directly because of the radial field at the helical electrodes.

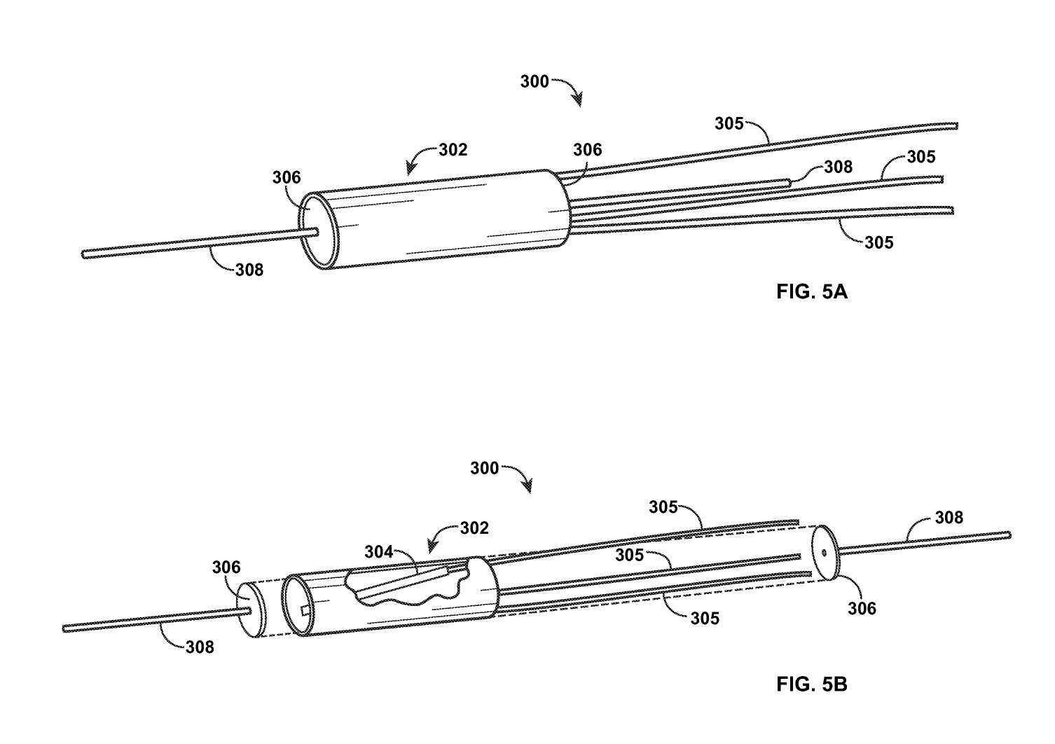

FIG. 5A shows a perspective view of the chamber insert 300 for the three-phase AC to DC transformer, with insulating insert housing 302; components thereof are shown in the axially “exploded” view of FIG. 5B. The helical electrodes 304 (only one shown in FIG. 5B) are fitted inside the insulating insert housing 302 and are equally spaced around the chamber circumference; e.g., three input helical electrodes are separated (i.e., offset circumferentially) by 120 degrees, and are connected to helical electrode leads 305. Each of the electrodes 304 preferably comprises at least one helically shaped portion (that is, a portion defining a segment of a geometric helix). The thick conducting wall 310 shown in FIGS. 2 and 4 conserves the flux on the 60 Hz time scale to control the magnitude of the radial magnetic field. The endcap electrodes 306 are connected to output leads 308.

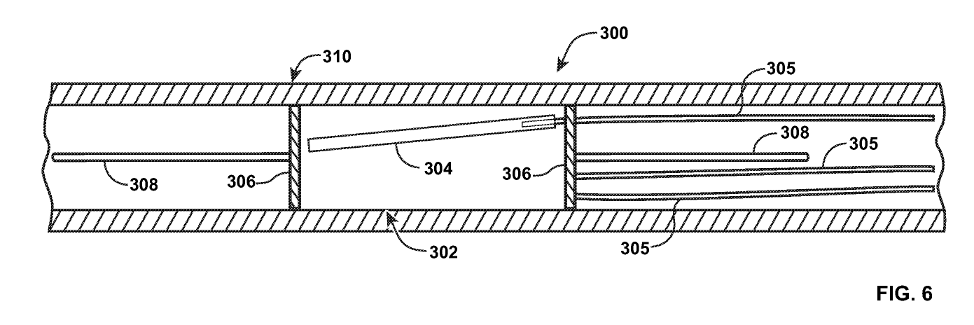

FIG. 6 is a cutaway diagram of the three-phase AC to DC transformer chamber insert 300 showing the vacuum chamber vessel's thick conducting wall 310, but not the exterior solenoidal coils. For the sake of clarity of illustration, only one of the three helical electrodes 304 is depicted in FIG. 6, but all three helical electrode leads 305 are shown. The endcap electrodes 306 and their leads 308 are also shown.

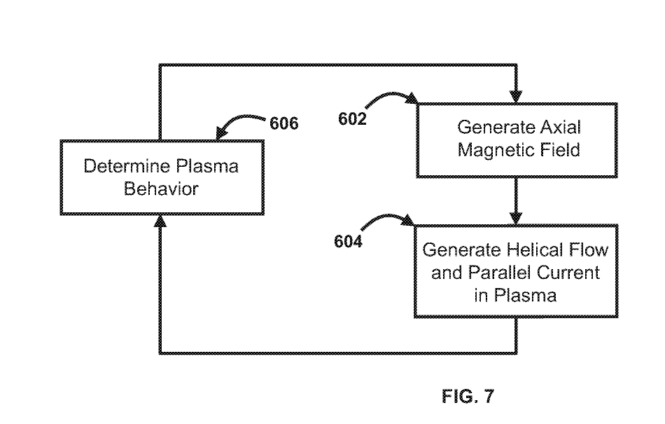

The flowchart of FIG. 7 illustrates that for three-phase AC to DC operation the method according to this disclosure preferably includes generating a substantially uniform axial magnetic field through a plasma (step 602) and generating a helical flow and directly driving parallel currents in the plasma (step 604), thereby generating a net electric current. The uniform axial magnetic field can be generated by a solenoid assembly 202 (FIG. 4). As an example, the solenoid assembly 202 can be disposed around the plasma, such as a solenoid housing. In an aspect, the helical flow driven by the helical electrodes 304 can be sheared in an axial direction relative to the plasma, and the current is generated in the axial direction. A drift speed of the plasma is a factor (e.g., fraction or multiple) of the Alfven speed. For example, the drift speed of the plasma can be between about 0.01 and about 400 times the Alfven speed. As a further example, the drift speed can be between about 0.01 and about 2 times the Alfven speed, between about 0.01 and about 10 times the Alfven speed, between about 0.01 and about 100 times the Alfven speed, between about 0.01 and about 200 times, or between about 0.01 and about 300 times the Alfven speed. Other ranges of factors can result from the systems and methods of the present disclosure. In another aspect, generating a helical flow in the plasma comprises generating one or more of a partial laminar flow and a turbulent flow in the plasma. In a further aspect, plasma behavior can be determined (e.g., estimated, simulated) using an MHD simulation (step 606 in FIG. 7). Accordingly, the magnetic field and therefore the helical flow generated can be configured and controlled based on the MHD simulation.

The flowchart of FIG. 7 illustrates the method of controlling the solenoidal magnetic field for the three-phase AC to DC transformer. The solenoidal coils 202 generate the axial field, per step 602, and this field plus the voltage on the helical electrodes 304 determine the helical plasma flow behavior, per method step 604. The plasma behavior then is used to modify the solenoidal currents driving the axial magnetic field.

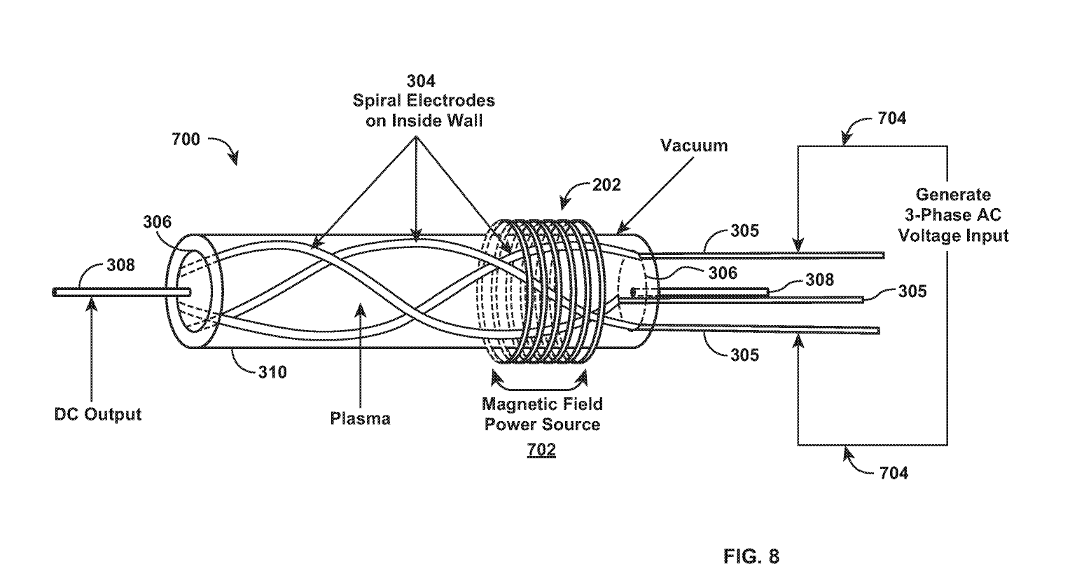

FIG. 8 is a schematic of the three-phase AC to DC transformer 700. The externally supplied magnetic field is from a magnetic field power source 702 with coils wound around a vacuum chamber having a thick wall 310. The helical electrodes (e.g., 304 in FIGS. 2, 5B and 6) provide three-phase AC voltage 704 to ionize to the gas within the tube chamber; in one embodiment the ionized gas thus converts into the plasma in the tube chamber. The electrodes 304 also provide a helical current with components parallel and perpendicular to the magnetic field supplied from source 702. The DC output voltage and current preferably is through the electrode leads 308. The thick vacuum chamber wall 310, conserving flux changes at 60 Hz, controls the radial magnetic field through the helical electrode 304, allowing parallel current to be driven in the plasma directly. The transformer system 700 in FIG. 8 can be integrated into and/or implemented in a variety of devices, systems, and/or applications, such as a commercial buildings, homes, factories and the like.

Thus there has been disclosed a system comprising a transformer configured to transform a first three-phase alternating current to a second direct current. In a preferred embodiment, the transformer includes an insert 300 (FIGS. 5A and 5B) defining a chamber having a thick wall 310 (see FIG. 4), configured to contain plasma, at least three (input) electrodes 304 disposed at least partially within the chamber defined by the wall 310 (see FIG. 4), and configured to direct the three-phase alternating current to induce motion in the plasma, thereby generating the direct current in the secondary (e.g., including at least two endcap electrodes 306 extending from the chamber) and configured to conduct the direct current from the chamber, and an electrical delivery network (including, e.g., endcap leads 308) electrically coupled to the at least two output or endcap electrodes and configured to conduct the direct current to at least one remote location. Each of the at least three electrodes 304 preferably comprises at least one helically shaped portion.

The chamber insert 300 preferably includes endcap electrodes 306 at opposite ends of the chamber, and wherein the electrode 306 conveys direct current from the chamber through the leads 308. The at least three electrodes 304 include at least three electrodes equally spaced around the chamber.

In a preferred embodiment, the transformer assembly further includes a solenoid disposed around at least a portion of an external wall 310 of the chamber, and an electric current passing through the solenoid induces a magnetic field within the chamber in an axial direction of the solenoid. Induced the motion in the plasma distorts the magnetic field, producing axial direct current within the chamber. In addition, the radial magnetic field allows plasma current parallel to the magnetic field to flow into the chamber. The vacuum chamber is of sufficient thickness and sufficiently high conductivity to conserve flux on the 60 Hz time scale.

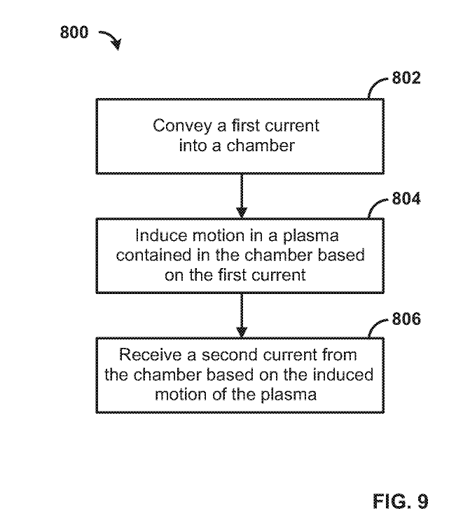

Attention is advanced to FIG. 9, providing a flow chart illustrating an example method 800 for transforming and/or converting a voltage and/or an electrical current. At step 802, a first current can be conveyed (e.g., provided, carried, transported, channeled) into a chamber. The first current preferably comprises a three phase alternating current. The first current can comprise a three phase alternating first voltage. For example, the first current can be conveyed to the chamber from a component of a power plant, power station, power line, and/or the like. The first current can be conveyed into the chamber via three or more input electrodes (preferably sets of three, e.g., three, six, nine . . . ). The three or more input electrodes can be disposed at least partially within the chamber. For example, the three or more electrodes can each comprise a first portion extending outside of the chamber and a second portion within the chamber. The first current can be through helical input electrodes.

The chamber may contain a gas, plasma, and/or the like. For example, the chamber can be filled with a gas, such as argon or hydrogen. The gas can be converted to plasma before, at the time of, or after the first current is conveyed to the chamber. The plasma and/or gas can be filled to a specified pressure (e.g., 1 mtorr) to achieve a desired behavior (e.g., motion or current) of the plasma and/or gas. The chamber can be configured (e.g., shaped) to cause, direct, constrain, control, and/or the like motion of the plasma within the chamber. For example, the chamber can be cylindrically shaped.

According to the system and method, a magnetic field can be generated through the plasma. For example, a wire proximate to the chamber can generate a magnetic field. The wire, which may define a solenoid, can be disposed (e.g., wrapped) around an exterior wall of the chamber. In an aspect, a protective layer (e.g., cover, shroud) can be disposed in between the wire and the chamber, as suggested by FIG. 3.

At step 804 of FIG. 9, motion can be induced in a plasma contained within the chamber based on the first current. For example, the first current can generate a second magnetic field within the chamber. The second magnetic field can be based on the path of the first current. For example, the three or more electrodes can be disposed, shaped, or the like, to generate an electric field between at least three of the one or more electrodes. In an aspect, the electric field can be a helically symmetric electric field. For example, the electric field can be rotated along the axis of the chamber. The electric field can cause, at least in part, the second current and/or the second voltage to be generated within the chamber. A distinct part of the current in the plasma is directly driven parallel to the magnetic field because of the radial magnetic field in the primary electrodes.

Inducing the motion in the plasma can distort the magnetic field, thereby inducing a second current within the chamber. Inducing motion in the plasma can comprise providing the first current through at least one helical electrode within the chamber. The induced motion can comprise helical flow sheared in an axial direction relative to the plasma. Induced motion can comprise a helical flow in the plasma. The induced motion may comprise a turbulent flow, a laminar flow, or a combination thereof. For example, the motion can be along a first direction at the center of the chamber. The motion can be along a second direction along interior walls of the chamber. The second direction can be opposite the first direction. The first direction and the second direction can be directions along (e.g., parallel to) the axis of the chamber.

At step 806, the second current can be received from the chamber based on the induced motion of the plasma. The second current in the present disclosure preferably comprises a DC current. As an illustration, the first current can comprise a three-phase alternating current and the second current can comprise a direct current.

The second current can be generated in an axial direction (e.g., along an axis or length of the chamber). For example, the second current can be generated along a line extending from a top (e.g., top cap) of the chamber to a bottom (e.g., bottom cap) of the chamber.

Furthermore, the first current can be conveyed with a first voltage. The second current can be conveyed with a second voltage. The second voltage can be a high voltage or low voltage in comparison to the first voltage. For example, the second voltage can be X (e.g., 1, 2, 3, 4, 5, etc.) orders of magnitude greater or less than the first voltage.

Thus there also has been disclosed herein a method comprising the basic steps of (a) conveying a three-phase alternating current into a chamber; (b) inducing motion or directly driving current parallel to the magnetic field in a plasma contained in the chamber based on the alternating current; and (c) receiving a direct current from the chamber based on the induced motion of the plasma. The method preferably further comprises the step of generating a magnetic field through the plasma, and wherein inducing the motion in the plasma distorts the magnetic field, thereby effectuating a step of inducing the direct current within the chamber. The step of inducing motion in the plasma preferably comprises providing the three-phase alternating current through at least three helical electrodes within the chamber. Also, inducing motion may comprise inducing a helical flow sheared in an axial direction relative to the plasma, and wherein generating the direct current comprises generating current in the axial direction. It is an advantage of the invention that inducing motion optionally comprises inducing a plasma flow that is sheared in an axial direction, such that the direct current is generated in the axial direction to flows out of the chamber through output electrodes.

The step of conveying a three-phase alternating current preferably comprises conveying with a first voltage, and further comprising a step of conveying the direct current with a second voltage. Also in the method, a solid endcap electrode preferably converts the axial currents in the chamber to a direct current. Multiple pairs of primary electrodes may be connected through an external rotor, and the primary electrodes convert axial currents in the chamber to a direct current. The step of inducing motion preferably comprises generating a turbulent flow, a laminar flow, or a combination thereof. Also, inducing motion may comprise inducing a helical flow in the plasma.

The foregoing examples are offered so as to provide those of ordinary skill in the art with a further disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This is true for any possible non-express basis for interpretation, including: matters of logic with respect to arrangement of steps or operational flow; plain meaning derived from grammatical organization or punctuation; the number or type of embodiments described in the specification.

Various publications are referenced herein above. The disclosures of these publications in their entireties are hereby incorporated by reference into this application in order to more characterize the state of the art to which the methods and systems pertain.

It will be apparent to those skilled in the art that various modifications and variations can be made without departing from the scope or spirit of the disclosed invention. Other embodiments will be apparent to those skilled in the art from consideration of the specification and practice disclosed herein. It is intended that the specification and examples be considered as exemplary only, with the scope of the invention being defined by the claims appended hereto.

What is claimed is:

1: An apparatus comprising:
a chamber configured to contain plasma;
at least three input electrodes disposed at least partially within the chamber and configured to receive a three-phase alternating current into the chamber, wherein the at least three input electrodes are configured to direct the three-phase alternating current to induce motion in the plasma, thereby to transform the three-phase alternating current;
a thick conducting wall external to the input electrodes to control a radial magnetic field through the electrodes; and
at least two output electrodes extending from the chamber, wherein the at least two output electrodes are configured to conduct a direct current from the chamber based on the induced motion in the plasma.

2: The apparatus of claim 1, wherein the at least three input electrodes are helical and equally spaced around the chamber.

3: The apparatus of claim 1, wherein the at least two output electrodes comprise an end cap disposed at a first end of the chamber and a split electrode disposed at an other end of the chamber, and further comprising at least two output leads wherein all output leads of the at least two output electrodes are disposed through the split electrode.

4: The apparatus of claim 1, wherein the at least two output electrodes comprise a first split end cap electrode disposed at a first end of the chamber and a second split end cap electrode disposed at an other end of the chamber, and further comprising output leads disposed through the two split end cap electrodes.

5: The apparatus of claim 1, wherein the at least two output electrodes comprise a first solid end cap electrode disposed at a first end of the chamber and a second solid end cap electrode disposed at an other end of the chamber, and further comprising output leads disposed through the two solid end cap electrodes.

6: The apparatus of claim 1, further comprising a solenoid disposed around at least a portion of an external wall of the chamber, wherein an electric current passing through the solenoid induces a magnetic field within the chamber in an axial direction of the solenoid.

7: The apparatus of claim 2, wherein the magnetic field is caused by the induced plasma motion to align at least in part with magnetic fields caused by at least a portion of the at least three input electrodes thereby inducing the second direct current within the chamber.

8: The apparatus of claim 1, further comprising a protective cover disposed between the solenoid and the chamber.

9: The apparatus of claim 1, wherein the at least three input electrodes comprise at least three alternating current input electrodes.

10: The apparatus of claim 2, wherein the thick conducting wall controls the magnitude of the radial magnetic field in the at least three helical electrodes, leading to parallel current being directly driven in the plasma;

11: A method comprising:
conveying an alternating current into a chamber;
inducing motion in a plasma contained in the chamber based on the alternating current; and
receiving a direct current from the chamber based on the induced motion of the plasma.

12: The method of claim 11, further comprising generating an axial magnetic field through the plasma, and wherein inducing the motion in the plasma distorts the magnetic field thereby inducing the direct current within the chamber.

13: The method of claim 11, wherein inducing motion in the plasma comprises providing the alternating current through at least three helical electrodes within the chamber.

14: The method of claim 13, wherein inducing motion comprises inducing a plasma flow sheared in an axial direction, and wherein the direct current is generated in the axial direction and flows out through output electrodes.

15: The method of claim 11, wherein conveying the alternating current comprises conveying with a first voltage, and wherein receiving the direct current comprises conveying the second direct current with a second voltage.

16: The method of claim 13, wherein inducing motion comprises generating a turbulent flow, a laminar flow, or a combination of turbulent and laminar flows.

17: The method of claim 13, wherein inducing motion comprises inducing a sheared flow in the plasma.

18: A system comprising a transformer configured to transform an alternating current to a direct current, the transformer comprising:
a chamber configured to contain plasma;
at least three input electrodes disposed at least partially within the chamber and configured to direct the alternating current to induce motion in the plasma, thereby generating the direct current in the secondary;
at least two output electrodes extending from the chamber and configured to conduct the direct current from the chamber; and
an electrical delivery network electrically coupled to the at least two output electrodes and configured to conduct the direct current to at least one remote location.

19: The system of claim 18, wherein each of the at least three input electrodes comprises at least one helically shaped portion.

20: The system of claim 18, wherein the chamber comprises a solid end cap and a split electrode disposed at opposite ends of the chamber, and wherein the split electrode conveys the direct current from the chamber.

21: The system of claim 18, wherein the chamber comprises an end cap and a solid electrode disposed at opposite ends of the chamber, and wherein the solid electrode conveys the direct current from the chamber.

22: The system of claim 18, wherein the at least three input electrodes comprise at least three sets of electrodes equally spaced around the chamber.

23: The system of claim 18, further comprising a solenoid disposed around at least a portion of an external wall of the chamber, and wherein an electric current passing through the solenoid induces a magnetic field within the chamber in an axial direction of the solenoid.

24: The system of claim 23, wherein the induced the motion in the plasma distorts the magnetic field thereby generating the direct current within the chamber which exits through the output electrodes.

25: The system of claim 18, further comprising a thick conducting wall placed at a position to control the magnitude of a radial magnetic field through the at least three helical input electrodes.
